(19) United States
(12) Patent Application Publication
(10) Pub. No.: US 2010/0240016 A1
(43) Pub. Date: Sep. 23, 2010

(54) COGNITIVE ASSESSMENT TOOL AND METHOD

(76) Inventors: Jon Ween, Whitevale (CA); Donald Stuss, Toronto (CA); Sandra Black, Toronto (CA)

Correspondence Address: MILLER THOMPSON, LLP, Scotia Plaza, 40 King Street West, Suite 5800, TORONTO, ON, M5H 3S1, CA

(21) Appl. No.: 12/728,524

(22) Filed: Mar. 22, 2010

Related U.S. Application Data
(60) Provisional application No. 61/161,844, filed on Mar. 20, 2009.

(51) Int. Cl. G09B 19/00

(52) U.S. Cl. 434/236

(57) ABSTRACT

The present invention is a cognitive test assessment tool and system incorporating either a single test or a test battery and a method of utilizing said tool and system. The tool may be compiled and ordered to addresses the particular assessment needs of patients groups determined in accordance with a diagnosis. The tool may incorporate an electronic device operable to provide elements of the test battery and to store information and/or transfer information to a storage means. Data regarding the process of the test battery, as well as that pertaining to the results of the test battery, can be captured in real time and stored locally and/or remotely. Said data may be assessed and may be utilized for reporting purposes. The data may be transferred to, or accessed by, other institutions in a format that is readable at the remote institutions and is consistent with circle of care regulations.

This application claims the benefit of U.S. Provisional Patent Application Ser. No. 61/161,844 filed Mar. 20, 2009.

### FIELD OF INVENTION

This invention relates in general to the field of cognitive capacity testing systems, more particularly the field of cognitive deficit or improvement assessment testing systems that are network-enabled.

### BACKGROUND OF THE INVENTION

Cognitive deficits associated with neurological diseases including stroke and dementia are: prevalent; contribute to poor outcomes; and represent barriers to community reintegration. The are also under-reported due to the lack of adequate and convenient assessment tools. For example, stroke is a leading cause of adult morbidity and mortality. Two main issues in particular have attracted the attention of those engaged in establishing innovative strategies for stroke care: 1) the presence of cognitive deficits in stroke survivors; and 2) inefficiencies in care delivery caused by inefficiencies in communication and data sharing between caregivers.

Cognitive deficits after stroke are estimated to occur in over 64% of stroke patients. These deficits are often poorly appreciated and their natural history is not well understood. It is suspected that much morbidity, suffering and health care utilization is under reported as a consequence of a low index of suspicion for such deficits (Hachinski, 2006, Stroke 37 (9) 2220-41). This situation is in large part due to the preponderance of cross-sectional studies and the lack of convenient, reliable and sensitive assessment tools across the continuum of care. There have been many calls to increase our understanding of cognitive deficits after stroke, and to develop a practical assessment tool that allows assessment of these deficits in a prospective and longitudinal manner.

Cognitive deficits may also be caused by conditions other than stroke, including certain injuries and drug administration. In most cases cognitive deficits are pervasive across the spectrum of cognitive function and are not isolated to specific areas. Executive deficits can be particularly prevalent, regardless of the lesion location.

It can be difficult to assess patients at varying levels of cognitive impairment. Sicker patients (for example those in the acute phase) simply may not be able to participate in extensive testing. Although it is vital to determine initial levels of impairment in order to best understand recovery profiles, obtaining data at acute time-points can be difficult.

Existing screening tools include the Mini-Mental Status Examination (MMSE) and the Montreal Cognitive Assessment (MoCA). These tools are brief in format and were created to address particular kinds of cognitive impairments. Generally, such tools are inadequate to address the broad range of cognitive impairment that may affect a stroke population.

Tools for the electronic application of tests and the capture of data relating to the test process for other types of conditions and therapies are known in the prior art. For example, PCT Application No. PCT/US2005/045684 discloses a neuropsychological testing product provided through an electronic means. The disclosed invention allows a user to select either an individual test or a battery of tests from a menu. A user may additionally build a custom-made test battery from the menu of available tests. PCT Application No. PCT/US2007/087546 discloses an interactive cognitive testing and assessment system for use with a variety of test batteries. The disclosed system includes a wireless communication module for connecting to a device or network for accessing an assessment and response centre.

U.S. Pat. No. 6,629,846 discloses another electronic psychological testing tool. This product involves a graphic input device whereby the process by which an examinee performs a psychological test is recorded and stored for assessment. The system of this invention can perform immediate data analysis or transmission. Additionally, psychological tests may include the use of an electronic tablet and writing utensil, such as is disclosed in U.S. Pat. No. 7,267,440. Moreover, the prior art testing methods applied in an electronic test include those that involve doctor patient interaction or involve a subject in isolation, as described in U.S. Pat. No. 7,163,513 and U.S. Pat. No. 7,186,116 respectively.

U.S. Patent Application No. 2007/0123757 discloses a computerized system for the administration of psychological tests. The integrated software and hardware components of the system are designed to require minimal examiner involvement while ensuring the collection of test data in a centralized data bank.

An additional drawback of the prior art is that once test results are gathered such information is slow to follow the patient as the patient moves through the continuum of health and social institutions. Distributed, referral-based systems of care are highly dependent on the information flow keeping up with the patient flow. If patients move through the system more quickly than their information decision-making will be hampered and time wasted. In particular repeated assessments and tests can occur due to the fact that care cannot advance without the critical information these provide. This is particularly noticeable in paper-based systems where information on pieces of paper may get lost, misplaced or “delayed” in the mail. This problem is exacerbated when patients move out of one local system of care and into another in a different locality. Such movement requires the specific copying and forwarding of documents which can be an inefficient and failure-prone method of information sharing.

Further drawbacks of the prior art arise because different approaches to assessment and reporting often involve descriptive languages unique to particular institutions. In some cases, information that is necessary for maximizing the benefit of a particular care event is not available at the point of care. This can lead to treatment time losses, an increased risk of morbidity and wasted health care dollars.

### SUMMARY OF THE INVENTION

In one aspect, the present disclosure relates to a method of utilizing a cognitive assessment tool comprising the steps of: configuring and arranging in a specific order one or more tests to operable to test a particular cognitive impairment; administering the one or more tests to a test subject, said administration utilizing a computer device operable to administer the one or more tests and to generate data as transferable data at least one of the following: before the one or more tests; during the one or more tests; between the one or more tests; and after the one or more tests; collecting the transferable data and transferring said transferable data to one or more data storage means; the one or more data storage means receiving the transferable data and storing the transferable data as stored data; and analyzing the transferable data or stored data to generate a cognitive assessment.

In another aspect, the present disclosure relates to a cognitive assessment tool to be utilized to test cognitive impairment of one or more patients, said cognitivie assessment tool being operable to administer one or more tests to test the cognitive impairment of the one or more patients, comprising: one or more computer devices operable to receive data as computer device input data and being linked to the data storage means, said one or more computer devices being operable to: administer the one or more tests; generate test data; and transfer at least one of test data and received data as transferable data; one or more data storage means operable to: receive at least one of transferable data and remote data source data transferred to the one or more storage means as received data; store the received data as stored data; and provide access to the stored data to one or more users; a data analysis means linked to one or more of the one or more computer devices or the one or more data storage means, said data analysis means being operable to access and analyze the transferable data and the stored data to generate cognitive assessment data, said cognitive assessment data being storable in the data storage means; a data access means linked to one or more of the one or more of the computer devices or the one or more data storage means, said data access means being operable to provide at least one of transferable data, stored data or cognitive assessment data in a user-readable format.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a flowchart of the process of applying the tool of the present invention.

FIG. 2 is a table listing the tests administered in a neuro-cognitive assessment of the present invention.

FIG. 3 is a table showing a correlated test battery and validation battery tasks of the present invention.

In the figures, embodiments of the invention are illustrated by way of example. It is expressly understood that the description and drawings are only for the purpose of illustration and as an aid to understanding, and are not intended as a definition of the limits of the invention.

### DETAILED DESCRIPTION OF THE INVENTION

The present invention is a cognitive test assessment tool and method of using said tool. The tool involves a set of cognitive assessment tests that are compiled and ordered, for example, such as into a test battery, to address the particular assessment needs of a patient or group of patients. Such assessment needs are determined in accordance with a patient's diagnosis. Furthermore, particular tests may be implemented upon an electronic device, for example, such as an electronic tablet. The device may be capable of storing information directly and/or transferring information to a storage means. Data regarding the process of the test as well as that pertaining to the results of the test, which may include scoring methods, can be collected, stored, and/or provided to a user. The collected data may further be utilized for reporting purposes. Reporting can involve the integration of data, or parts of the data, with other data sources. In one embodiment the present invention may be an integrated, community wide system that facilitates the collection and dissemination of data between providers, and conducts the flow of patient care, within and across institutions.

As an example, a test battery of one embodiment of the present invention addresses the five major domains of cognitive function, including: frontal lobe function (e.g., simple attention, psychomotor speed, executive function); language; praxis; visuospatial; and memory (e.g., verbal and visuospatial). This embodiment of the present invention may incorporate a battery of tests that represents a comprehensive and balanced assessment of cognitive function sensitive to all five major domains of cognitive function and the relation of these to a patient's neurological disorder. It may be applied by way of an electronic testing tool that standardizes test administration, automates scoring and data basing, formalizes reporting and facilitates access to data across a care continuum. Test performance may be assessed across a spectrum of measures and error patterns. Assessments may be across tasks, be task specific, or involve only specific chosen tasks. Analysis may be applied at varying levels of detail. A skilled reader will recognize that a variety of assessment and analyses may be applied to the tests and/or test batteries of embodiments of the present invention.

Test performance may be assessed by a variety of assessment means. For example, a spectrum of measures and error patterns may be analyzed in details in the course of test performance assessment. In some embodiments, the present invention may be configured to analyze error patterns within and across tasks. Performance measures such as, for example raw scores, time to complete one or more tasks, as well as other details, including finer grained details, may be utilized in the test performance assessment. The present invention may apply a method of recording actual responses occurring during one or more tests and of comparing these to a target string. Raw scores may be analyzed based on target patterns being investigated, such as, for example orders (e.g. order of responses to a task, test or battery of tests, etc.), errors, repetitions, or intrusions. This may enable fine grained error and pattern analysis pertaining to a task involved in a test.

Utilizing this fine grained error and pattern analysis pertaining to one or more tasks involved in a test it may be possible to examine organizational strategy and to compare the relevant patterns across and between tasks. The comparison may occur between tasks pertaining to a single test, or may be applied to tasks occurring within multiple tests. Embodiments of the present invention may incorporate both, or one of, cross-task analysis and cross-test analysis.

The present invention may further detect characteristics and details of the response of one or more patients to a task, test or battery of tests. The responses may be categorized, such as, for example response in blocks, distributed performance, quick responses, and slow responses. A skilled reader will recognize that additional patterns may be detected and analyzed in the test performance assessment. A skilled reader will further recognize that different test performance assessments and patterns may be applied and detected during the course of a test, or at the conclusion of a test when all data pertaining to one or more tests is collected.

To facilitate the distribution of assessment data the present invention tool for cognitive assessment may include a technological infrastructure including elements, for example, such as a database, a server and a tablet interface. Through the application of this tool, a user may apply an assessment test, or battery of tests, specific for a particular vascular cognitive impairment based on consensus criteria. Furthermore, the technology infrastructure may be applied in a manner that integrates cognitive testing, clinical practice, data sharing and communication. One means of achieving this is an embodiment of the present invention that includes an electronic assessment form and case record framework. Another means is an embodiment of the present invention that incorporates a virtual regional network. The facilitation of shared information undertaken by embodiments of the present invention may provide a base to generate standardized referral documentation to care providers across the continuum. This may be used to create a secured, shared regional data base for translational care, education and research opportunities and/or to promote opportunities for collaborative development and testing of stroke care interventions across the continuum of care.

The present invention provides a benefit over known prior art as good clinical care is dependent on communication amongst care providers, as well as on reliable and interpretable data. The reliability and interpretability of data may be particularly critical for complex data. The present invention may facilitate communication and data sharing amongst caregivers within an institution or between institutions. The present invention may further support standardized data gathering, coding and dissemination. This can allow for all caregivers to review the assessment data in a common format and language, which may further facilitate clear discussion amongst caregivers.

Two elements of embodiments of the present invention may assist in standardizing the test and/or test battery provided as well as the assessment data gathered therefrom, namely: a) an electronic device, for example, such as an electronic tablet-PC interface, may standardize test administration; and b) a shared, common and secure, yet easily accessible, database framework may standardize test assessment data communication.

The tests provided by the present invention individually or included in a test battery, may vary and may be tailored to specific conditions, injuries or other assessment groupings of adults. For example, a test battery may be created to be applicable to the assessment of categories of people, for example, such as, people who are in a particular stage of aging, such as people over the age of 70; stroke patients; people experiencing dementia; people who have Parkinson's Disease, or other degenerative conditions; people who have sustained traumatic brain injuries; or even persons taking particular pharmaceutical drugs. Each of these groups may require a specific test, or a particular test battery to assess their levels of cognitive impairment, rehabilitation status and/or recovery progress. For example, a group of persons over 70 may have impaired motor functions and require a test battery employing tasks that involve a specific testing infrastructure, for example, such as the application of a stylus tool. In another example, groups of people involved in clinical trials for new drugs may be administered a different test battery to assess any effects of the drug on cognitive function.

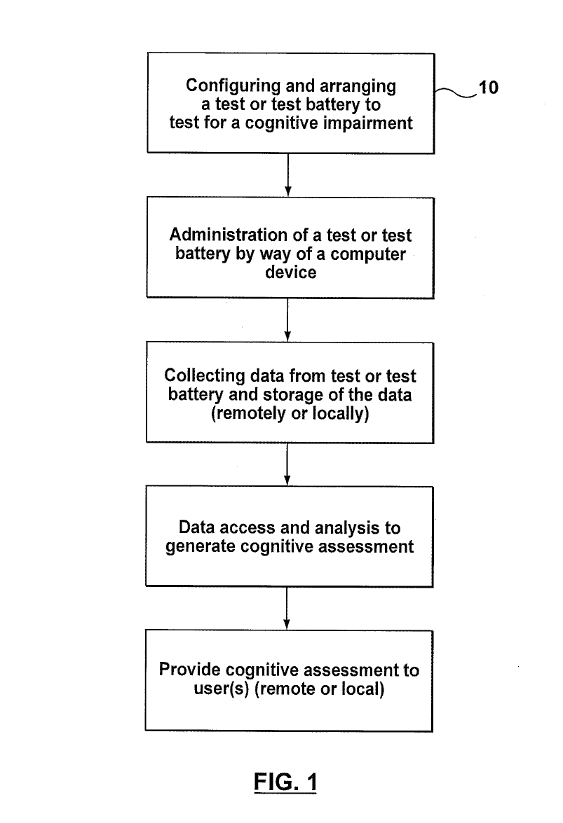

In one embodiment of the present invention, as shown in FIG. 1, a method of producing a cognitive assessment may be undertaken. A test or test battery may be configured and arranged to test for at least one cognitive impairment 10. The test or test battery may be administered by way of an electronic device that may be a computer device, and such administration may further involve in some instances a test administrator, such as a doctor. Data may be collected from the test or test battery administration, this data may be collected by the computer device, or by a test administrator. Data collected by the computer device may be stored in a storage means, for example, such as a database incorporated in a server device. This application will describe a storage means linked to one or more electronic devices, this description includes electronic devices incorporating a storage means, or a storage means outside the electronic device or located remotely from the electronic device. If a test administrator collects data this data may be inputted into the computer device or directly to a storage means. The storage means may be located locally, such as a storage means integrated with the computer device, or may be remote from the location of the computer device. The link between the computer device and the storage means may be direct, wireless, or of any other sort.

The method of the present invention may be operated by way of one or more software code or program code products. The software or program code (herein referenced as software code), which may represent one or more software code products, may be operable to undertake several functions and/or operations including: performing one or more steps for each test including individual tasks involved in the tests (e.g., drawing a line between two items in the course of a test, etc.), collecting data related to each test and/or task; analyzing the data collected prior to a test, after a test, or during a test; undertaking a cognitive assessment based upon any collection of data (including data accessed from a remote data source, such as, for example a data source of an institution), test, task, battery of tests, or multiple tasks, etc.; allowing a user to choose a single test or a series of tests to be provided to a user; providing one test or a series of tests to a user, being a battery of tests; allowing a user to enter data; transferring data to a storage means that is linked to the electronic device; generating reports based upon the data that may incorporate data relating to an individual test, cross-test data, and/or cross-task data. Reports may be generated relating to a specific patient or to a group of patients.

A skilled reader will recognize that the software code may be operable to undertake additional steps relating to the tasks, including additional steps disclosed herein. For example, the software code may interpret data, utilizing an interface, and cause such data to be compatible with data from other data sources that are otherwise incompatible, as described below. A skilled reader will further recognize that the software code of the present invention may be coded in a variety of programmable computer languages.

Collected data, or stored data, may be accessed for analysis to generate a cognitive assessment. The cognitive assessment may be provided to one or more users located either locally where the test battery was administered, or located at a remote site, such as a hospital or other institution.

In one embodiment of the present invention, a tablet-PC interface may be applied for cognitive assessment and clinical data gathering. A skilled reader will recognize that other interactive, network-enabled interfaces may also be applied, such as a personal digital assistant, a laptop, or any other such device. It may be possible to apply different interfaces at points where the test or battery of tests is provided, however, the application of a particular interface means generally may support the standardization of the cognitive assessment. However, certain interfaces will have particular benefits for specific patient groups. As an example, use of a tablet-PC or similar tool allows for ease of application for many patient groups, for example, it is manageable for older patients.

In an embodiment of the present invention, different interfaces linked to electronic devices may be offered to patients taking a test or battery of tests at various locations, and a means of standardizing the captured assessment data may be applied by the present invention. Thus, the present invention may facilitate the standardization and assessment of data obtained from many locations. Standardization may be undertaken to create standardized data from data provided from various data sources. Standardization may involve translation of data into a common data language. The data in each data source, for example, such as data from a patient record database of an institution and data from the battery of tests of the present invention, may be of variant types. The standardization interface may be operable to produce data that is standardized and therefore compatible. Compatible data may be assessed and analyzed by the present invention to provide results and reports.

Standardization of the data collected by the interface and/or the assessment data compiled from the collected data is a benefit of the present invention over the prior art in that such data may be easily shared and understood by caregivers, even those who are located in places remote from the point where the test or battery of tests is applied to a patient.

The data collected by the electronic device generally may include: any answers provided by the patient, for example, such as final answers to a test, or any answers provided in the course of a test; any strokes made by the patient in the course of completing a test, for example, such as a stroke made upon an electronic device; any time records, for example, such as the time to make a stroke upon an electronic device, the total time to complete a test, or any other time periods calculated; or any other information gathered by the electronic device at the beginning of a test, during the course of the test, or at the end of the test.

Assessments of cognitive deficiencies may utilize data collected from the test or battery of tests provided to a patient in accordance with the present invention. Assessments may further utilize data from another data source, for example, such as patient data from an institution. In this embodiment the electronic device utilized for a patient to undertake a test will be linked to the system of the present invention, as will the one or more additional data sources from which data is accessed to be utilized in the assessment. The assessment steps may vary for each test, or battery of tests. Assessment steps may further vary in accordance with the cognitive deficiency to be assessed, for example, such as reaction to a specific drug, rehabilitation, aging, etc. A skilled reader will recognize how the purpose of the cognitive deficiency tests and assessment generally may affect the assessment steps.

The assessment data of the present invention may include any or all of the data collected by the interface, any computation, sum or result achieved based upon the data collected by the interface.

Transfer of the assessment data may lead to knowledge translation between various levels of a research and/or care continuum. An embodiment of the present invention may facilitate portability of data collected from the interface and assessment data between different system configurations, for example, such as, hardware, operating systems and browsers.

In another embodiment of the present invention, a shared, common and secure database framework may be generated amongst a research and/or care continuum. The database may be the storage means. Embodiments of the present invention may incorporate a variety of links between the elements of the present invention, and particularly between the hardware elements. Additionally, the software code products of the present invention may be operable by various elements of the present invention.

For example, in one embodiment of the present invention, an electronic device may be linked, directly, wirelessly, or by any other means, to a storage means. Data may be transferable between the electronic device and the storage means. The storage means may be a database and/or server.

In another embodiment of the present invention, two or more electronic devices may be linked, directly, wirelessly, or by any other means, to a storage means. One test or a battery of tests may be operable on the electronic device and data may be transferable between the electronic devices and the storage means.

In yet another embodiment of the present invention one or more electronic devices may be linked, directly, wirelessly, or by any other means, to a storage means and possibly also one or more data sources of one or more institutions. Data may be transferred between each electronic device and the storage means, between the electronic device(s) and the other data source(s), and/or between the storage means and the other data source(s). Data transferred from the other data source(s) may be translated through a standardization interface if necessary. The standardization interface and assessment software code programs may be operable by the storage means and/or the electronic device.

In still another embodiment of the present invention one or more electronic devices may be linked, directly, wirelessly, or by any other means, to a storage means. The storage means may be linked, directly, wirelessly, or by any other means, to one or more data sources of one or more institutions. Data may be transferred between the electronic device and the storage means, as well as between the storage means and the other data source(s). Data transferred from the other data source(s) may be translated through a standardization interface if necessary. The standardization interface and assessment software code programs may be operable by the storage means and/or the electronic device.

A skilled reader will recognize that the configurations of the system of the present invention described above are merely examples of possible configurations. Other configurations are also possible.

Generally in some embodiments of the present invention, the configuration and framework of the present invention may aid in the standardization and facilitation of communication amongst care providers by ensuring that there is no need for data to move from the storage means to be shared. Instead, only access permissions must be granted in accordance with standardized, secure procedures, whereby access to the database may be permitted. The database further may facilitate the collection of information in real time with point-of-care data entry, obviating the need for slow, costly and error-prone chart abstraction as in registry-type data systems.

In yet another embodiment of the present invention, the invention may be operable to anonymize data and grant access to this anonymized data in a fashion regulated by standard ethics review processes. This can provide a secure and manageable way to gather, store, disseminate and analyze health care information. A close link between clinical and research efforts with a common data and technological infrastructure can greatly facilitate knowledge translation and advance the quality of care for patients with neurocognitive deficits. A skilled reader will recognize the advantages of this embodiment towards reaching such a goal.

As embodiments of the present invention may be applicable to different groups of patients needing cognitive assessment, a skilled reader will further recognize that elements of the invention may be altered depending on the group or patient taking the test, or battery of tests. For example, the ergonomics of the stylus may be difficult for patients with severe weakness or patients with tremors. Also, sound output from the tablet may be too weak for noisy environments, such as wards, as well as for patients who are hard of hearing, such as older patients. Additionally, elements of the test may be flexible so as to be administered with pencil-and-paper equivalents in some cases. In such an embodiment, some of the tests may be applied electronically and others may be applied by the test givers by way of pencil-and-paper versions. If a pencil-and-paper version of one or more tests is given, the data and/or results of the test(s) may be entered into the system of the invention, either through the electronic device, or directly into the storage means.

Features of embodiments of the present invention may include software that allows for true portability between different system configurations (e.g., hardware, operating systems and browsers); network connectivity optimized to enable true roaming of the tablet interface and to facilitate use at all points of care; and full integration into the care and clinical environments through resource allocation within participating care groups to support an automated care record. These features are intended to create a system that is simple, scalable and extensible. A skilled reader will recognize that a variety of hardware and software tools may be utilized in embodiments of the present invention.

Regarding simplicity, in one embodiment, the present invention may be intuitively approachable, requiring a minimum of training to use. The tests, data capture, assessment, reporting and other aspects of the invention may incorporate use of: drop-down menus; check boxes; and standardized responses. Other features may also be included in embodiments of the present invention to generally facilitate data entry, ease of use and data reliability.

Regarding scalability, in one embodiment, the present invention may be centrally managed. For example, the storage means and the architecture may be offered from a central location, and may be accessible and operable by participants at remote locations. In this case data may not be transferred to the remote location, or minimal data may be transferred, the one or more tests, data collection, assessments, etc., may be operated by a central management protocol that is integrated with or linked to the storage means. In this embodiment of the present invention, a remote participant can undertake one or more tests and access data. The invention may allow for the addition of new participating practitioners, sites and functions. In one embodiment of the present invention, the concept of the plug-and-play architecture of the Internet may be applied in the present invention.

Regarding extensibility, in one embodiment, the addition of new data tables, assessment tools and reports should be straightforward and require minimal programming and development expertise.

In one embodiment of the present invention, the database may be ported from one database type into another database type. Specific databases may quantify the neurological and cognitive assessment in a standardized, problem-oriented way. A skilled reader will recognize that the database may be replicated at all participating institutions to ensure data security (e.g., from server crashes/corruption) and to provide rapid access. Privacy (e.g., access security) may be ensured through database encryption, password-enabled levels of access to data, membership in predetermined “circles of care”, encrypted transmission for synchronization and a thin-client-sever configuration where no data is housed on the client. A skilled reader will recognize that other embodiments of the present invention are possible and that other means of achieving privacy may be applied thereto.

In one embodiment of the present invention, a system may be configured to facilitate distributed responsibility for gathering different data elements. Such an approach may not only minimize the burden of collection on any one individual or professional domain and leverage the expertise of different groups of providers in obtaining the most accurate and reliable information possible; it can also make the fruit of one person's labour available to facilitate the labour of others. Data may be captured once and reduplication of even simple tasks may be avoided.

In embodiments of the present invention, several design features may all be implemented, or selected features may be implemented. Strict confidentiality of patients' health records may be maintained by the system design. In the case of security breach, the information leakage should be minimal to null. The design may be decentralized and flat. The decentralized architecture of the present invention may implement the same resources at each node. A benefit of this architecture is that should one node fail the other nodes can continue and may fill any gap produced by the failed node. Consequently, a health care facility or other similar entity that is linked into multiple nodes may experience the autonomous continuation of operation in the event of a failure of inter-participant communication lines. In one embodiment, the system supports simple maintenance, affordable by any participant, including those of the public sector. The system may include a self-sufficient subsystem that could be grafted to any existing network with no adjustments to the latter. The system may be built from mass produced, low-end consumer electronics devices readily available off-the-shelf to ensure best quality/price ratio. The system may have an open source orientation with an objective of unimpeded future distribution of the developed product, as well as elimination of licensing expenses. A web-based, platform- and operating system-independent application may be constructed. Also, a parsimonious selection of programming environment may occur for each part of the project.

Several additional components may be elements of embodiments of the present invention. A skilled reader will recognize that these components may be applied in a variety of combinations in embodiments of the present invention. The components may include the following:

1. Data Sharing and Security

Prior art paper-based systems where information on pieces of paper may get lost, misplaced, or “delayed” in the mail, encounter the problem that patients move through the system more quickly than their information. This can hamper decision-making and waste time. Moreover, the problems can become more pronounced when patients move out of one local system of care and into another as movement requires the specific copying and forwarding of documents, which can be an inefficient and failure-prone method of information sharing.

In one embodiment of the present invention, the “copy and forward” step is obviated by mirroring the database at all participating care-giving instances, eliminating the need for information to be physically moved from one location to another, and requiring only a change in access rights to patient information. Such a feature can help alleviate the problems of the prior art and limit instances whereby that the patient moves through the system faster than their data, as well as the need for re-harvesting of information. The present invention may liberate resources to focus on interval changes and care decision-making.

Mirroring the database may create some security and access concerns. In a paper-based system, security is maintained by locking the paper records in a secure environment. Transfer of paper-records can be monitored with sign-in/out logs, but there can be no control over the record once it leaves the locked storage. Security in electronic record keeping systems can be accomplished in many different ways, as transmission and access to information can be fairly easily regulated and monitored. Most electronic record systems regulate access to data by using secure, encrypted storage environments and by login access rights. Once inside the system, however, most electronic health records (EHRs) do not restrict access to individual pieces of data, but rather gather information about access events through audit trails. Inappropriate access cannot be completely prevented and requires monitoring of the audit trails for inappropriate access events.

In one embodiment of the present invention, security in the electronic record keeping system is achieved using encrypted storage and password protection. All servers may reside behind firewalls and data synchronization may occur for only very short periods of time and over encrypted connections, so that the total exposure of EHR data to the outside environment is minimal.

In another embodiment of the present invention, the regulation of data access may be achieved by circle-of-care (COC) definitions. Each user may be assigned to a user category (e.g., one of clerical, allied health, physician, administrator and researcher). These groupings may determine which segments of the database the user is allowed to access. For example, the clerical group may be granted access to demographic data but not clinical data, physicians may be granted access to all care-related data, and researchers may be granted access to de-identified data after the appropriate research ethics board approval.

In addition to sequestering access to data on a “need-to-know” basis, access to individual patient identifiable data may be regulated by a COC policy. Identifiable data may be accessible only by personnel involved in the patient's COC. Care providers may be assigned to a patient's COC either at the time of initial admission to the system or by the referral process. As a patient is referred from one provider group to another, the referral process may add the new provider group to the patient's COC and the patient's data may become accessible to the new group. This COC approach, being a strict, dual-tier access policy, may eradicate the need to implement an audit trail.

2. Database

In one embodiment of the present invention, the COC approach is implemented at the database level. This may be used to delineate how access to data of each particular patient is granted to medical personnel.

In another embodiment, a secure synchronization suite may be coded for the server databases.

In yet another embodiment of the present invention, a variety of reports may be created based upon the database. For example, branded reports for each participating institution may be generated and a streamlined report established. Additionally, information regarding the tests, test performance, results, scoring means, or percentile information, to name a few examples of possible reporting information, can be integrated into reports. The reports can be depicted in different forms including written and graphic forms. An example of the graphic form report is a star-chart for the patient, whereby patient results are plotted as a function cognitive domain, or a line-chart as a function of time and where a prediction made as to how the patient will do in the future in accordance with whether there is an incline or decline in the plot with increasing time. Such a prediction may be utilized in relation to the recovery of a patient and can be captured to reflect month, days, years, or other time lines, whereby tentative treatment or other decisions, such as when a patient may need to be moved to or from a nursing home, rehabilitation facility, hospital, or home, may be based on the curve of the graph. Reporting in any form may also be utilized to capture test-norms and to provide standards for certain injuries or conditions, or benchmarks for certain interventions such as the effect of rehabilitation after a stroke or the rate of decline after the onset of dementia. From this information, the optimum time to administer a test battery may be identified for various groups of patients, for example in accordance with age or condition, although other groups may also be identified.

The information system can be run as a separate, stand-alone part of a hospital computer network or can be integrated into any existing information system, provided that the existing information system is open, i.e. it can accept and issue data in non-proprietary formats. The system may also be integrated into a closed proprietary system.

In yet another embodiment of the present invention, data may be utilized as a research tool for the purpose of additional research or one or more patient care projects.

In one embodiment of the present invention data may be collected in real time. The facilitation of real time data collection is an improvement over the prior art as it may reflect the situation at point of care. Consequently, it may be possible to gather accurate data as the information will be captured immediately and not rely upon the memory of the care giver or other professional to recall information accurately for a time prior to such information being recorded.

In another embodiment of the present invention, the data collection may be customized to reflect guidelines for cognitive testing. As research continues to augment the knowledge in this sector such guidelines may be subject to change. The creation of a customizable database structure may allow for modifications thereto which incorporate new research into the testing structure, as well as the data output therefrom.

3. Networking

In one embodiment of the present invention, the system may mimic the Internet in that may have no central control node, which also means that it may have no central point of failure. This feature has far reaching implications such as ultimate ease of scalability and multiple levels of redundancy, both of which may render any backup solution superfluous. Each participating hospital may have a server with its own database. At regular intervals, such as, for example, nightly, every hour, or any other interval chosen by the operator, each participant may securely update its system across one or more nodes (e.g., participating institutions), so as to cause the databases in each location to be identical except for data related to the institutional branding. The system may therefore have as many backup copies as there are nodes.

In another embodiment of the present invention, only specified information may be updated at each participating node.

In yet another embodiment of the present invention, adding a new hospital or other institution to the system, or removing a hospital or other institution from the system, would not change the operation of the existing nodes, similar to the connection of a new computer to the Internet which does not change operation modes of already connected computers.

4. Tablet-PC Interface

In one embodiment of the present invention, a tablet interface is employed to capture data in real time. Real time data may include a collection of behavioural responses elicited by the patient in the course of undertaking a test or test battery. Such behavioural responses may be captured, for example, on timescales of 10's to 100's of milliseconds. A skilled reader will recognize other determinable data that may be utilized for this purpose.

In one embodiment of the present invention, tablet functionality may be preferred for the tasks that most closely depend on the use of the tablet interface, such as, for example, the cognitive testing battery. The tablet may be reliable for this functionality and patients may adapt well to the interface.

In another embodiment of the present invention, a hybrid system may be employed, where multiple tasks, such as, for example voice activation, may be performed on a desktop PC station while other, real time tasks, such as, for example assessment and testing, may be accomplished on the tablet.

5. Hyperacute Stroke Module

In one embodiment of the present invention, a palm-PC interface for use in the emergency room may be implemented. Such an application of the present invention may also be utilized by EMS personnel in the field to facilitate hyperacute management, and to enable the collection of more complete patient information from the field for rapid presentation to receiving teams. Additionally, using this kind of system would standardize data gathering, enable the instantaneous generation of reports and allow for quality monitoring and improvement.

6. Acute Stroke Module

In one embodiment of the present invention, an acute stroke module may be implemented for application in cognitive assessment of stroke patients. The assessments obtained from the acute stroke module could be used to assist in the evaluation of the extent of impairment and location of impairment as well as progress of impairment over time.

7. Motor/Rehabilitation Module

In one embodiment of the present invention, a motor/rehabilitation module may be implemented to facilitate the collection of data into a core data repository for a series of rehabilitation assessment units. In this regard, the system may be used to bank assessments as a tool for monitoring the effectiveness of rehabilitation initiatives on cognitive function specifically as demonstrated through motor-function.

8. Cognitive Rehabilitation Module

In one embodiment of the present invention, a cognitive rehabilitation module may be implemented for application in the treatment of patients with cognitive deficits due to stroke or other condition. An embedded technology infrastructure, whereby several participants are joined, may allow for the development of a capacity to administer the cognitive rehabilitation battery remotely. Further linkages, such as one with an organization such as telehealth, may allow for high level neurological expertise to be made available to remote areas within the existing telehealth framework or similar networks.

9. Imaging Module

In one embodiment of the present invention, a comprehensive, academic neuroimaging module may be an element of the present invention. The imaging module may merge or interface with the system in a productive way and enable the user to review scan data on the same interface that also presents the clinical data, such as the test results and scores. The neuroimaging may also enable more sophisticated, three-dimensional image viewing.

In another embodiment of the present invention, the results of cognitive testing may be integrated with clinical and radiological information. A wide spectrum of information concerning the patient, including severity of sensory and motor deficits, cognitive deficits and lesion characteristics, such as, for example, those identified on CT scanning or MR imaging, can be assimilated and used to develop a standard rating scheme. For example, functional magnetic resonance imaging may be applied during real time cognitive testing, using a subset of the test battery, providing a link between image analysis and behavioral data (e.g., test results and scores) to determine lesion-behavior correlations. In this regard, the system may semi-automatically analyze the scans in the database, optionally with some interaction by the user to identify the lesion, and calculate an expected set of scores based on the lesion-behavior data in the database.

### TESTS

Embodiments of the present invention may include various cognitive assessment tests either as a test battery or as a single test. The following provide examples of some of the tests that may be provided in isolation or included in a cognitive testing battery. A skilled reader will recognize that other known and novel tests may be developed for application in the test battery. Additionally, the tests may be grouped into specific classifications and groups. The collection and arrangement of tests in a battery may be in accordance with a particular cognitive limitation or other criterion. A skilled reader will recognize that the specific tests may be altered and substituted without affecting the novelty of the test battery of the present invention, as may the groupings and ordering of the tests within a test battery.

1. Frontal Lobe Function Tests

A. Simple Attention Tests

The ability to maintain simple attention to a task is critical for participation in any cognitive activity Simple attention can be affected by damage almost anywhere in the brain, though it is predicted to be mostly mediated by the frontal lobes. A commonly accepted task as a measure of simple attention is the Digit-span forward test. This test assesses the ability to correctly repeat a sequence of numbers of increasing length and is widely used in the evaluation of stroke patients and for other cognitive assessments, where the test captures the ability to maintain simple attention to a task.

B. Psychomotor Speed Tests

Psychomotor speed relates to accomplishing cognitive activities successfully in real time, and is critical for all cognitive function. The mesial frontal cortex in both hemispheres, as well as deeper cerebral structures such as the basal ganglia, are believed to be responsible for psychomotor speed function. Speed of processing is generally measured on timescales of 10's of milliseconds to seconds. Thus, timed tasks are critical to assessing psychomotor speed. Such tasks include:

i) Part “A” of the trail-making task (Trails A) where the subject may be asked to connect a numbered series of dots in the correct order as quickly as possible. The time to complete this task may be measured and utilized in the evaluation and scoring. A standardized version of this test exists, but a modified version shorter in duration and compatible with the tablet PC may be applied.

ii) A subject may be asked to count backwards from 20 by “1” as rapidly as possible. This task is commonly used in clinical neurology and can be an indicator of simple attention and basic psychomotor speed.

iii) A subject may be asked to count backward from 40 by “3” as rapidly as possible, for example, 40, 37, 34, etc. This task requires some attention splitting and can be more complex and slower to perform. This task is also commonly applied in clinical neurology testing.

iv) The Sustained Attention Reaction Time (SART) test evaluates a subject's ability to rapidly identify a target and avoid distracters, measuring the number of “correct hits”. It requires a high level of attention and discrimination, and the ability to suppress more automatic responses. The computer visually presents a sequence of numbers (1-9) for 200 milliseconds at 1-second intervals. The subject is instructed to tap each number as fast as possible but not to tap the number “3” when it appears. The basic test design may be adapted and modified to be compatible with the tablet-PC for application of the present invention.

C. Executive Function Tests

Executive function is probed by tasks that require more complex division of attention and switching from one task to another. The dorsolateral convexities of the left and right hemispheres are responsible for these more complex attentional abilities. The following tasks may be utilized to probe these abilities:

i) The digit span backwards test measures the ability to repeat a sequence of numbers of increasing length in reverse order and is a simple test of more divided attention.

ii) Generation of a lexical word-list (e.g. words beginning with the letter “F”) measures the ability to spontaneously generate a number of exemplars in 60 seconds.

iii) Part “B” of the trail-making, wherein the subject may be asked to “connects the dots” in alternating numbered and lettered sequence (e.g. 1-A-2-B-3, etc.) as quickly and as accurately as possible, measuring the ability to maintain attention on a more complex set of instructions and to avoid distracters. During the course of this task and errors made in the execution of the task may be measured. A shorter version of the standardized test may be applied in the present invention.

iv) The Sustained Attention Reaction Time (SART) test (described above) may also measure the number of misses and correct hits in addition to the response time recorded above.

v) The Sustained Attention Reaction Time (SART) false alarm reaction time test measures the response time for false hits (a measure of impulsivity) and compares this to the reaction time for correct hits.

vi) The “Coin-Switch” task is a simple bedside test of a subject's ability to identify patterns of events, identify changes in these event patterns and successfully alter behavior in response to these event changes. The subject is presented with a coin then the coin is hidden in a hand of the examiner and moved from hand to hand in a particular way, hidden from the subject's view. The initial pattern is simple: the coin simply alternates from hand to hand. Once the subject recognizes the pattern (by correctly identifying the hand holding the coin five times in a row), the pattern is switched to a more complex one (the coin stays in each hand for two presentations before moving to the other hand). The subject is allowed 10 presentations to determine the pattern of coin-movement.

2. Language Tests

Language tasks are most commonly dependent on function in well-described areas of the left frontal and temporal lobes. Tasks that probe language abilities may include:

i) Phrase length is a measure of language ability quantifiable by simple observation of casual interaction or in response to a specific prompt (e.g. a picture or hypothetical scenario). In general, phrase lengths of greater than 7 words are considered to be fluent, while shorter phrase lengths are indicative of decreased fluency.

ii) Generation of a word list based on semantic criteria (animal names). This probes language fluency and measures the ability to spontaneously generate a number of exemplars in 60 seconds. A commonly used clinical task available in the public domain can be adapted for the test battery of the present invention.

iii) A picture-naming task probes the ability to identify line drawings of objects in a series of increasing difficulty (lower frequency in common speech). A task commonly used in aphasia assessment can be modified that utilizes 15 public domain line drawings.

iv) The rhyme judgment task measures whether or not a subject can discern if visually presented words rhyme. This task probes a subject's phonological capability, and provides a measurement of the ability to discriminate word sounds between different classes of words, whether visually similar or not, thus, stratifying the degree of task difficulty and allowing evaluation of error profiles (developed by Dr. Nichole Anderson, Kunin-Lunenfeld Applied Research Unit, Toronto, ON).

v) Simple word and phrase repetition can be used to assess phonological ability, where errors in word sound and sequence is indicative of language impairment.

vi) Basic comprehension can be assessed by measuring the ability to follow simple commands requiring “yes” or “no” answers.

vii) Comprehension is assessed by asking the subject to correctly follow instructions by manipulating colored tokens in a 4×5 field across the computer screen. The subject uses the stylus to touch the tokens in sequence and move them around the screen in a prescribed sequence (adapted from a standardized 60-token version). This test can be used as a more demanding and sensitive test of comprehension ability, supplementing the command/question task described in vi).

3. Praxis Tests

The test battery may include tests to quantify the number of correct gestures, or learned motor movements, the subject is able to perform. Praxis is predicted to be dependent on left hemisphere cortical areas. Deficits in praxis would suggest damage to the left side of the brain. Four gestures in each of three categories can be probed, each of which is in common usage in clinical practice:

i) Facial expression and gesture tests.

ii) Limb gestures that do not require an object (intransitive, e.g. waving goodbye).

ii) Limb gestures that require an object (transitive, e.g. brushing ones teeth with a toothbrush).

4. Visuospatial Tests

The test battery may include tests to assess visuospatial function a measurement of the ability to accurately analyze space and a body's relationship to space. Visuospatial function relies on right frontal and parietal cortical and subcortical areas. Tests that probe visuospatial function include:

i) Marking a line presented on the computer screen at its midpoint to assess orientation to both sides of space (also referred to as the line bi-section task, in common use). An embodiment of the present invention may employ three separate displays of lines of lines of varying lengths having slightly different left-to-right location relative to display midline and will calculate an average deviation from midline across the three presentations.

ii) Drawing an analog clock showing a time of “10 minutes after 11” (in common use) with a modified rating system (3-point versus common 15-point rating system). This task may be recorded in real-time, strategies analyzed and scoring may be in either a simplified 3-point system or a more complicated scheme.

iii) Copying a moderately complex 2-dimensional geometric figure for probing more sophisticated ability to divide attention to details across space (geometric figure developed by Dr. William Milberg and standardized for use in the “Geriatric Evaluation of Mental Status (GEMS) assessment). In one embodiment the drawing could be captured in real-time to assess strategies and sequencing.

iv) A symbol cancellation with distracter stimuli can be used to measure the ability to distribute attention across space. The test enables quantification of object-centered neglect compared to spatially centered neglect. Circular stimuli with segments of the circle missing on the right hand side or left hand side of the circle are scattered across the visual environment (page) and the subject is instructed to cross out the circles missing a left-handed defect wherever they encounter them. The number of neglected left defect circles in the left side of space can be determined as a measure of space-centered neglect. As well, the number of left-side defect circles vs. right-side defect circles checked can be determined as a measure of object-oriented neglect.

5. Memory Tests

The test battery may include one or more tests to measure memory function, the ability to store and retrieve information. Tasks to assess this ability include:

i) Orientation to place and time to assess for basic memory function (commonly used task in the public domain).

ii) Ability to spontaneously recall recent community and/or news events as a measure of implicit, episodic verbal memory.

iii) Ability to recognize previously presented pictures (the 15 Snodgrass figures from the picture-naming task described above) from foils to measure implicit, episodic visual and verbal memory.

iv) Ability to correctly learn, recall and recognize a five-word list is a task (commonly used task in the public domain) as a measure of learning ability (encoding), storage and retrieval of verbal material.

v) Ability to correctly remember the composition of the previously copied complex geometric figure as a measure of visuospatial memory.

In one embodiment of the present invention, the system may be designed to allow error monitoring across cognitive domains as well as across individual tasks themselves. This is advantageous in light of the fact that a patient can misperform tasks in any of number of ways. The system may be able to analyze whether errors are random or systematic. For example, the system may be able to detect perseveration from previous response, or inability to follow the stated rule or some form of an internally generated rule. For example, in some tests a list of words and/or a list of pictures for recall have items in common that could result in mixing of the lists under circumstances where a patient has a particular frontal deficit. In another embodiment of the present invention, the system may allow for analysis of intrusive errors (e.g., visuospatial biases) across tasks, which is not easily accomplished with paper-and pencil task-sets. In yet another embodiment of the present invention, the system may provide for a determination of a relation of detected error patterns to disease characteristics (e.g., dementia versus stroke, or stroke in a particular region of the brain). In an embodiment of the present invention wherein the analysis algorithms are embedded in the system, there may be no need for effortful and error-prone scoring by the test administrator and results may be relatively quickly generated and compared to the normative sample in the dataset.

### EXAMPLE

A test project of an embodiment of the present invention has been undertaken. A skilled reader will recognize that the details of this test represent only one embodiment of the present invention and do not limit the scope of the invention in any manner. Hardware for the project was selected among mass produced and popular tablet PC devices having built-in sound cards, sufficient powerful for the needs of the project and ergonomic characteristics relevant to the patient population.

A magnetic stylus was used for the tablet-PC interface to enable the user to rest his or her wrist on the screen. However, the ergonomics of the magnetic stylus were found to be very similar to the ergonomics of a pen and may have resulted in rapid hand movements, extreme tilt of the pen, and hand tremor, each of which can result in unpredictable test results, though such problems were rare in the test implementation. In addition, a parallax was observed in patients asked to handle the magnetic stylus for the first time, though this was easily overcome.

Adherence to Open Source operating systems (OS) allowed the developers to maintain control over the technological environment. It was important to look for an opportunity to reduce the footprint of the operating system so that the resources of the computer would not be self-serving, (i.e. monopolized by the OS for its own use). The OS provided the convenience of recompiling the kernel to suit individual needs and to achieve the most precise patient response time registration. The decision to utilize one operating system and one browser on all client tablets was made in order to reduce the costs of support and maintenance. It would be understood by the person skilled in the art that more than one operating system and more than one browser could be utilized.

Difficulties adapting to the tablet interface were noticed mostly in patients in the very early acute phase of stroke who were quite ill. In the rehabilitation and ambulatory/outpatient settings, there were only occasional problems with patients dealing with the interface. In terms of broader functionality for data entry, point-and-click response items were observed to be useful, although the server-thin client configuration caused some noticeable slow-downs. For free-text entries (such as narrative opinions, etc.), the tablet interface was less useful as the screen-size and tablature are both small and somewhat cumbersome.

Initial investigations were conducted into voice-activation data entry functionality, though the technical difficulties in adapting open source voice technology to the system was more than the project could absorb. It is also quite possible that the tablet PCs would have not been powerful enough to successfully implement voice data entry.

A total of 440 batteries were performed (336 patients and 104 controls) at three test sites (Baycrest (Toronto, ON), Sunnybrook Health Sciences Centre (Toronto, ON) and St. John's Rehabilitation Hospital (St. John's, NF). The age of individuals tested ranged from 19 to 95 (66+/−16), 69+/−14 for patients and 57+/−19 for controls, t=−2.78, p=0.006. Education of tested individuals ranged from 0 to 30 years, 14+/−1 for patients and 15+/−4 for controls, t=3.00, p=0.003. Since there were significant differences in age and education observed between patient and control groups, age and education were always entered as covariates in any analysis.

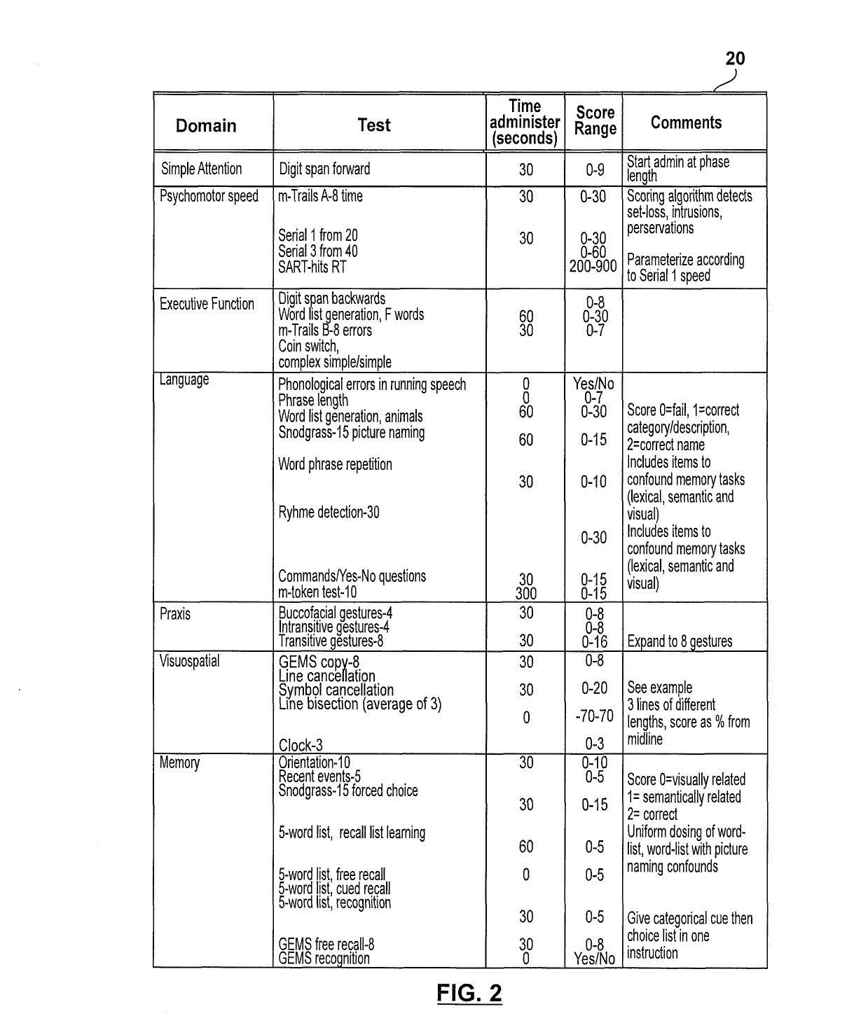

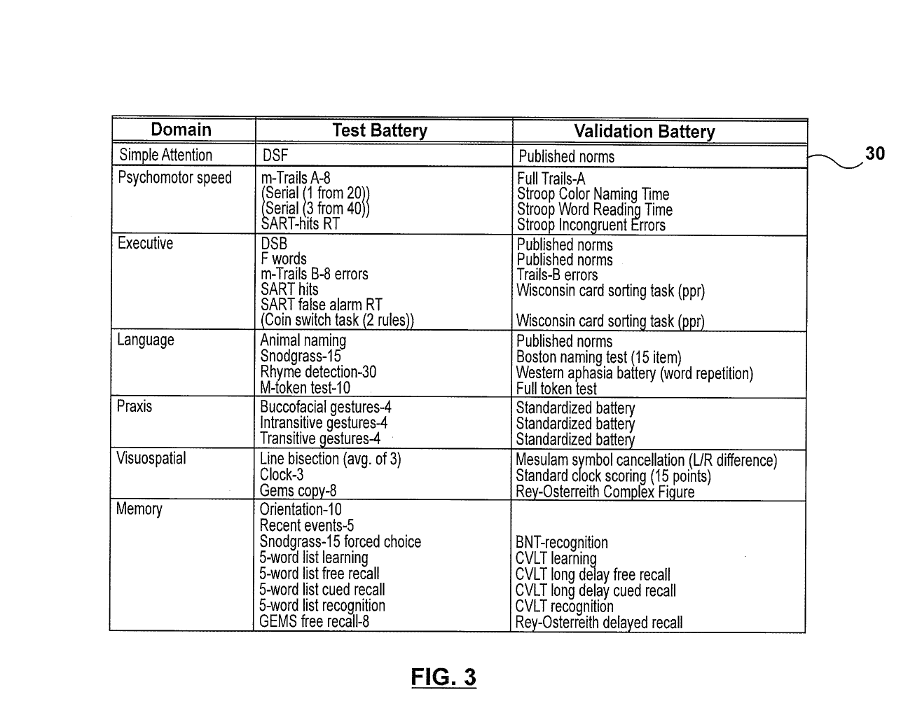

The battery consisted of a total of 24 sub-tasks of 18 tests in 7 major groups. The tests administered in the battery are shown in FIG. 2, such as the Simple Attention Test 20. Of the 336 patients studied, 67 underwent a validation battery (20%). As shown in FIG. 3, a comparison of the test battery and validation battery tasks was undertaken, such as a comparison pertaining to the Simple Attention Test 30.

88 of 104 control individuals (85%) received the validation battery as well as the tablet battery. At least some form of imaging data was available for 97 of 128 (75%) patients from the Sunnybrook test site and for 114 of 298 (38%) from the Baycrest test site. Since lesion characteristics typically correlate with observed clinical characteristics, the lack of scan data for 100% of those tested speaks to the incompleteness of available data for decision-making presently encountered in clinical settings. It is possible that scan data availability at the Sunnybrook test site was underestimated due to the fact that the scan data were abstracted into the database off-line. Scan availability at Baycrest was accurately reported as scan assessment is entered into the database as a part of routine clinical practice providing a 100% capture rate of available scan data. No scan data was available for individuals tested at the St. John's site.

The project team analyzed the data in accordance with criteria, including the age effect, education effect, patient control, etc. A skilled reader will recognize that a variety of criterion may be applied to evaluate a testing battery depending on the patient population to undergo the test. In general, there was good correlation between battery tasks and validation tasks in the control group, suggesting construct validity. No effects of gender on task performance were identified. Patient test results were typically found to be lower than those of control subjects, though some tests showed ceiling and floor effects that confounded interpretation. Education effects (contributing to improved performance) were typically less noticeable in the patient group than in the control group, suggesting that education may not help cognitive function after stroke as much as it might in patients with degenerative disorders such as Alzheimer's Disease.

Correlations between patient tablet-battery results and the validation-battery results were less consistent. This was likely due to the heterogeneity of lesion distribution which is predicted to contribute to the observed variance as a patient's performance on a particular task is anticipated to vary depending on the lesion location (e.g. left vs. right hemisphere, superior vs. inferior lateral, etc.) in a task-dependent manner.

There was little or no observed effects of time post-onset as a factor of patient location (acute care, rehabilitation or outpatient groupings) versus time post-onset, on task performance. The data indicated that patient location did not impact test performance (e.g. patient in the acute setting performed similarly compared to patient in the outpatient setting), suggesting that a level of persistent impairment is likely significant in longer term care of stroke survivors, or possibly that the subject sample was too heterogeneous to permit the identification of a location-specific trend in performance.

We claim:

1. A method of utilizing a cognitive assessment tool comprising the steps of:
a. configuring and arranging in a specific order one or more tests to operable to test a particular cognitive impairment;
b. administering the one or more tests to a test subject, said administration utilizing a computer device operable to administer the one or more tests and to generate data as transferable data at least one of the following: before the one or more tests; during the one or more tests; between the one or more tests; and after the one or more tests;
c. collecting the transferable data and transferring said transferable data to one or more data storage means;
d. the one or more data storage means receiving the transferable data and storing the transferable data as stored data; and
e. analyzing the transferable data or stored data to generate a cognitive assessment.

2. The method of claim 1, comprising the further step of configuring and ordering the one or more tests that include at least the following types of tests: a frontal lobe function test; a language test; a praxis test; a visuospatial test; and a memory test.

3. The method of claim 1, comprising the further step of generating a list of the one or more tests viewable by a user on the computer device and permitting the user to choose the one or more tests to be administered to the test subject.

4. The method of claim 1, comprising the further step of generating transferable data that includes at least one of the following: one or more final answers to a test; one or more answers provided in the course of a test; one or more strokes made by the subject in the course of completing a test upon the computer device; one or more time records, including at least one of time to make a stroke upon the computer device, total time to complete a test, other time periods calculated.

5. The method of claim 1, comprising the further step of analyzing the transferable data to categorize responses to one of the one or more tests, or to one or more tasks involved in one of the one or more tests as at least one of the following: response in blocks, distributed performance, quick responses, and slow responses.

6. The method of claim 1, comprising the further step of reporting the cognitive assessment to a user.

7. The method of claim 1, comprising the further step of performing at least one of the following: cross-test analysis; and cross-task analysis.

8. The method of claim 1, comprising the further step of integrating at least one of the following to the transferable data to be analyzed to produce the cognitive assessment: data entered into the computer device by a user; data entered into the one or more data storage means by the user; data transferred from one or more remote data sources.

9. A cognitive assessment tool to be utilized to test cognitive impairment of one or more patients, said cognitivie assessment tool being operable to administer one or more tests to test the cognitive impairment of the one or more patients, comprising:
a. one or more computer devices operable to receive data as computer device input data and being linked to the data storage means, said one or more computer devices being operable to: administer the one or more tests; generate test data; and transfer at least one of test data and received data as transferable data;
b. one or more data storage means operable to: receive at least one of transferable data and remote data source data transferred to the one or more storage means as received data; store the received data as stored data; and provide access to the stored data to one or more users;
c. a data analysis means linked to one or more of the one or more computer devices or the one or more data storage means, said data analysis means being operable to access and analyze the transferable data and the stored data to generate cognitive assessment data, said cognitive assessment data being storable in the data storage means;
d. a data access means linked to one or more of the one or more of the computer devices or the one or more data storage means, said data access means being operable to provide at least one of transferable data, stored data or cognitive assessment data in a user-readable format.

10. The cognitive assessment tool of claim 1, wherein at least one of the one or more data storage means is a database.

11. The cognitive assessment tool of claim 1, wherein the one or more tests include at least one test from each of the following test categories: frontal lobe function tests; language tests; praxis tests; visuospatial tests; and memory tests.

12. The cognitive assessment tool of claim 1, wherein the cognitive assessment tool further comprises a standardization interface linked to at least one of the one or more computer devices and the one or more data storage means, said standardization interface being operable to standardize to a specific data format the computer device input data; the test data; the remote data source data; the received data; stored data; and cognitive assessment data.

13. The cognitive assessment tool of claim 1, wherein the one or more data storage means is one data storage means linked to the one or more electronic devices, said one data storage means being further linked to one or more remote data sources and operable to receive data from the one or more remote data sources as the remote data source data and to transfer data to the one or more remote data sources.

14. The cognitive assessment tool of claim 13, wherein the data transferred to the one or more remote data sources from the one data storage means is cognitive assessment data.

15. The cognitive assessment tool of claim 13, wherein the one or more remote data sources are remote institutional databases.

16. The cognitive assessment tool of claim 13, wherein the one data storage means is a central processing means operable to: administer one or more tests to test the cognitive impairment; employ the data analysis means; and employ the data access means.

17. The cognitive assessment tool of claim 13, wherein data stored in the one data storage means is mirrored at the one or more remote data sources.

18. The cognitive assessment tool of claim 1, wherein all data stored in the one or more data storage means is at least one of: encrypted; and anonymized.

19. The cognitive assessment tool of claim 1, wherein the data access means operates at least one of: an imaging module; and a reporting module.

20. The cognitive assessment tool of claim 1, wherein at least one of the computer devices is a tablet-PC interface.
